(19) United States
(12) Patent Application Publication
(10) Pub. No.: US 2026/0246053 A1
(43) Pub. Date: Aug. 20, 2026

(54) BATTERY PACK

(71) Applicant: Prime Planet Energy & Solutions, Inc., Tokyo (JP)

(72) Inventor: Yozo UCHIDA, Toyota-shi (JP)

(21) Appl. No.: 19/446,939

(22) Filed: Jan. 13, 2026

(30) Foreign Application Priority Data
Feb. 20, 2025 (JP) 2025-025894

(51) Int. Cl. H01M 50/242; H01M 10/04; H01M 10/613; H01M 10/6556; H01M 50/291; H01M 50/204

(52) U.S. Cl. CPC H01M 50/242; H01M 10/0468; H01M 10/613; H01M 10/6556; H01M 50/291; H01M 50/204

(57) ABSTRACT

A battery pack includes battery cells and a restraint mechanism. Each of the battery cells has a battery can consisting of an extruded case body in the form of a quadrangular tube that is open at opposite ends in an axial direction, and a pair of lids that seal the opposite ends. The extruded case body has a pair of long side portions extending in the axial direction (Z direction), and an upper short side portion and a lower short side portion. The restraint mechanism holds the battery cells in place by applying pressure to the battery cells. The restraint mechanism includes a cooling unit that contacts the lower short side portion and cools the battery cells, and the widthwise opposite end portions of the lower short side portion are formed to be engageable from above with protrusions formed on an upper surface of the cooling unit.

### CROSS-REFERENCE TO RELATED APPLICATIONS

This application is based upon and claims the benefit of priority to Japanese Patent Application No. 2025-025894 filed on February 20, 2025, the entire contents of which are incorporated herein by reference.

### BACKGROUND

### Technical Field

The disclosure relates to a battery pack formed by assembling battery cells that constitute a secondary battery used as a power source for hybrid vehicles, electric vehicles, and so forth.

### Related Art

In general, secondary batteries used as power sources for hybrid vehicles, electric vehicles, etc. are required to pass large currents at high voltages. Therefore, a battery pack formed by assembling multiple battery cells is used. One example of the battery pack, in which prismatic battery cells are stacked in a series arrangement, includes a restraint mechanism that applies pressure to the outermost battery cells inward in the stacking direction to hold the battery cells in place. The restraint mechanism is often equipped with a cooling unit that contacts the bottom surface portions of the battery cells and cools each of the battery cells (see, for example, Japanese unexamined patent application publication No. 2022-866 (JP 2022-866 A)).

### SUMMARY

### Technical Problems

However, the restraint mechanism normally does not restrain the top parts of the battery cells. Thus, when the pressure inside a case rises due to a rise in the temperature of the battery cell during rapid charging of the battery cell, for example, the bottom surface portion of the battery cell bulges downward in an arc shape, and the contact area between the bottom surface portion of the battery cell and the cooling unit is reduced, resulting in a reduction in the cooling performance of the battery cell. When an electrode body expands in volume as the battery cell ages and deteriorates, too, the bottom surface portion of the battery cell bulges downward in an arc shape, and the contact area between the bottom surface portion of the battery cell and the cooling unit is reduced, resulting in a reduction in the cooling performance of the battery cell.

When the battery pack is assembled by stacking the battery cells in a series arrangement, the positions of the stacked battery cells may shift little by little relative to the restraint mechanism, causing a “snake phenomenon” where the array of the battery cells is curved in the stacking direction. In this case, defects are likely to occur in the connection points between conductors (bus bars) connecting current collector terminals of the respective battery cells and the current collector terminals.

The disclosure was made in view of the above problems, and provides a battery pack that can suppress the reduction in the cooling performance of battery cells and the snake phenomenon with a simple structure.

### Means of Solving the Problems

(1) One aspect of the disclosure for solving the above problems is a battery pack including a plurality of battery cells that constitute a secondary battery and a restraint mechanism. Each of the battery cells has an electrode body, and a battery can made of metal and comprising an extruded case body in the form of a quadrangular tube that contains the electrode body and is open at opposite ends in an axial direction, and a pair of lids that seal the opposite ends of the extruded case body. The extruded case body has a pair of long side portions extending in the axial direction, and an upper short side portion and a lower short side portion perpendicular to the long side portions. The restraint mechanism holds the battery cells in place by applying pressure to the battery cells from opposite ends in a stacking direction in which the battery cells are stacked with intervening members sandwiched between the long side portions. The restraint mechanism includes a cooling unit that contacts the lower short side portion of each of the battery cells and cools the battery cells, and the lower short side portion has widthwise opposite end portions formed to be engageable from above with protrusions formed on an upper surface of the cooling unit.
(2) In the battery pack described in (1) above, the lower short side portion may have a larger thickness than the upper short side portion.
(3) In the battery pack described in (1) or (2) above, the widthwise opposite end portions may have arc surfaces that protrude outward in a width direction and extend along the axial direction, and the protrusions may be elastically deformable and engageable with the arc surfaces.
(4) In the battery pack described in (1) or (2) above, the widthwise opposite end portions may have inside walls that are recessed upward from a bottom surface of the lower short side portion, and the inside walls may be provided with engaging claws that are elastically deformable and extend along the axial direction. The protrusions may be engageable with the engaging claws from below.
(5) In the battery pack described in any one of (1) to (4) above, the extruded case body may include a partition wall portion that extends in the axial direction between the lower short side portion and a lower end portion of the electrode body, to connect the long side portions or the long side portions and the lower short side portion, and the extruded case body may have a coolant passage between the partition wall and the long side portions and the lower short side portion.

### BRIEF DESCRIPTION OF THE DRAWINGS

FIG. 1 is a schematic cross-sectional view of a battery pack according to one embodiment;

FIG. 2 is a side view of a battery cell that constitutes the battery pack shown in FIG. 1;

FIG. 3 is an enlarged cross-sectional view of part A of the battery pack shown in FIG. 1;

FIG. 4 is an enlarged cross-sectional view of part A in a first modified example of the battery pack shown in FIG. 1;

FIG. 5 is an enlarged cross-sectional view of part A in a second modified example of the battery pack shown in FIG. 1;

FIG. 6 is an enlarged cross-sectional view of part A in a third modified example of the battery pack shown in FIG. 1;

FIG. 7 is an enlarged cross-sectional view of part A in a fourth modified example of the battery pack shown in FIG. 1; and

FIG. 8 is an enlarged cross-sectional view of part A in a fifth modified example of the battery pack shown in FIG. 1.

### DETAILED DESCRIPTION OF THE EXEMPLARY EMBODIMENTS

### Detailed Description of Battery Pack

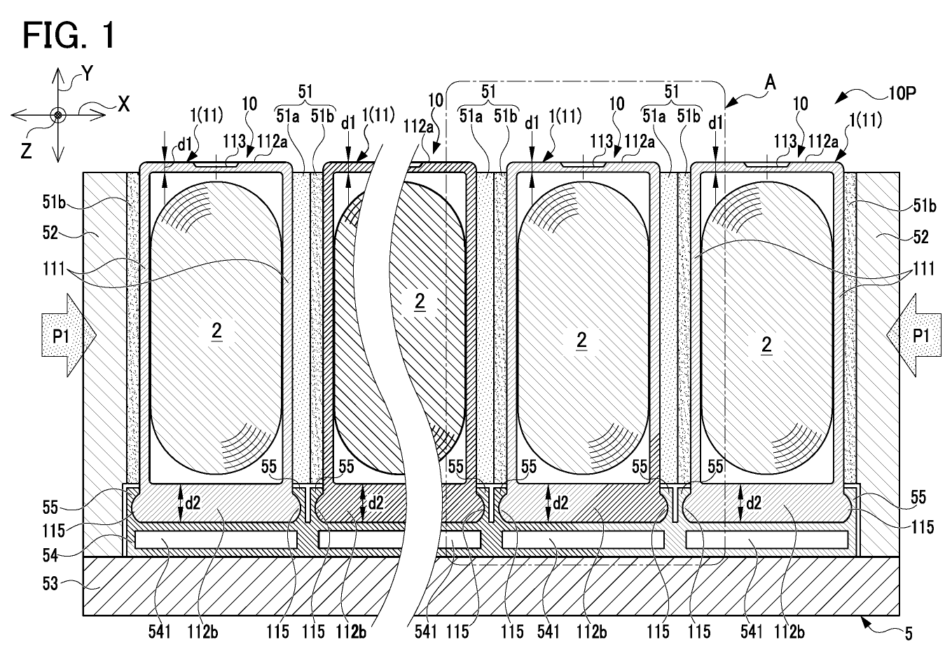

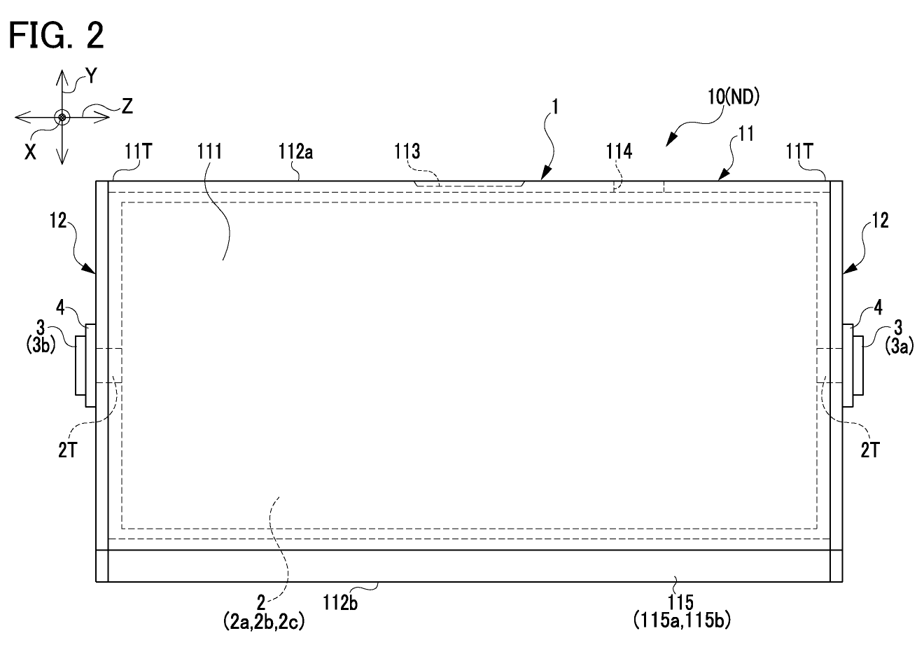

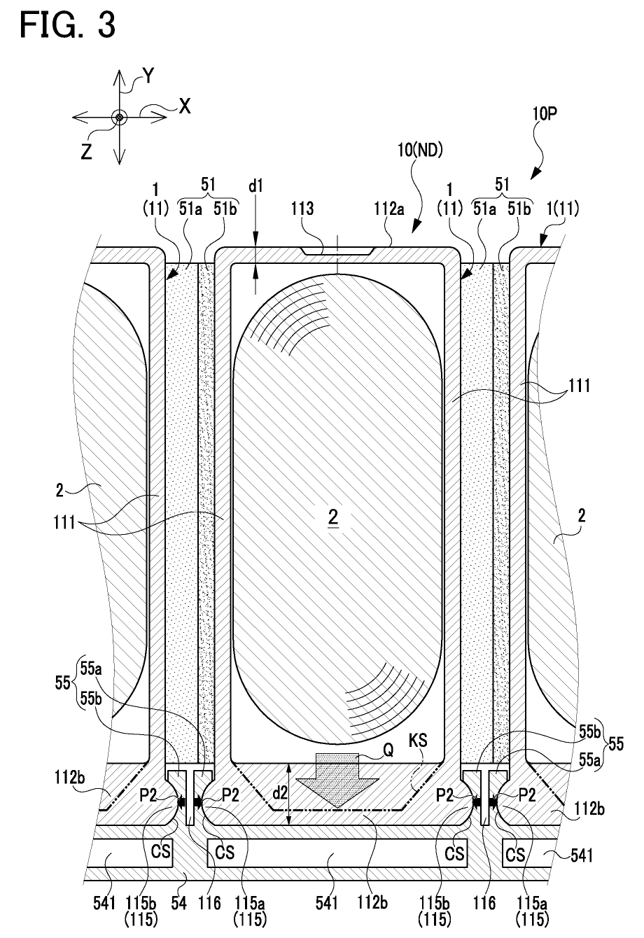

Next, the overall configuration of a battery pack according to one embodiment of the disclosure will be described in detail with reference to the drawings. FIG. 1 is a schematic cross-sectional view of the battery pack according to the embodiment. FIG. 2 is a side view of a battery cell that constitutes the battery pack shown in FIG. 1. FIG. 3 is an enlarged cross-sectional view of part A of the battery pack shown in FIG. 1. In FIGS. 1 to 8, the X direction indicates the stacking direction of battery cells in the battery pack, the Y direction indicates the vertical direction of the battery cell (extruded case body), and the Z direction indicates the axial direction of the extruded case body. The X direction is also the width direction of an upper short side portion and a lower short side portion, the Y direction is also the width direction of a long side portion, and the Z direction is also the axial direction of an electrode body.

As shown in FIGS. 1 to 3, the battery pack 10P according to one embodiment of the disclosure includes battery cells 10 that constitute a secondary battery ND and a restraint mechanism 5. Each of the battery cells 10 has an electrode body 2, and a battery can 1 made of metal and consisting of a quadrangular tube-like extruded case body 11 that is open at opposite end portions 11T in the axial direction (the Z direction) and a pair of lids 12 that seal the end portions 11T. The battery can 1 contains the electrode body 2, and the extruded case body 11 has a pair of long side portions 111 extending in the axial direction (the Z direction) and an upper short side portion 112a and a lower short side portion 112b perpendicular to the long side portion 111. The restraint mechanism 5 applies pressure from the opposite ends in the stacking direction (the X direction) to the battery cells 10 to hold them in place, in a condition where the battery cells 10 are stacked with intervening members 51 sandwiched between the long side portions 111.

The electrode body 2 includes a strip-shaped positive electrode foil 2a, a strip-shaped negative electrode foil 2b, and a strip-shaped separator 2c sandwiched between the electrode foils 2a, 2b. The electrode foils 2a, 2b and the separator 2c are wound into a flat shape and laminated to form the electrode body 2. However, the electrode body 2 is not necessarily limited to this type. For example, the electrode body may be formed by laminating multiple sheets of positive electrode foils, multiple sheets of negative electrode foils, and multiple sheets of separators sandwiched between the positive and negative electrode foils. An insulating film (not shown) is interposed between the electrode body 2 and the battery can 1 and serves to prevent the electrode body 2 and the battery can 1 from short-circuiting. The insulating film may be made of, for example, polypropylene (PP) resin.

The battery cell 10 that constitutes the secondary battery ND may be, for example, a lithium-ion secondary battery. In this case, an aluminum foil, for example, may be used as the positive electrode foil 2a, and a lithium transition metal oxide (e.g., LiNi_{1/3}Co_{1/3}Mn_{1/3}O₂, and LiNiO₂), for example, may be used as an active material adhered to the positive electrode foil 2a. Meanwhile, a copper foil, for example, may be used as the negative electrode foil 2b, and graphite, hard carbon, soft carbon, etc. may be used as an active material adhered to the negative electrode foil 2b. A porous sheet of polypropylene or polyethylene, for example, may be used as the separator 2c.

The metal battery can 1 is made of, for example, aluminum or an aluminum alloy, but is not necessarily limited to this. The extruded case body 11 is in the form of a quadrangular tube having a generally rectangular cross section, and has a pair of large-width long side portions 111 and small-width upper short side portion 112a and lower short side portion 112b, which extend in the axial direction (the Z direction). The extruded case body 11 is a tubular body formed by extrusion molding in the axial direction (the Z direction) and is open at the opposite end portions 11T in the axial direction (the Z direction). A safety valve 113 that breaks and opens when the pressure inside the battery can 1 rises to a predetermined level or higher and an inlet 114 through which electrolyte is injected into the battery can 1 are formed in the upper short side portion 112a.

The end portions 11T of the extruded case body 11 are connected by welding, or the like, to the lids 12 in the form of flat plates. Current collector terminals 3 connected to tab portions 2T formed at the opposite ends in the axial direction (the Z direction) of the electrode body 2 are fixed to the lids 12 via insulating materials 4. Specifically, a positive current collector terminal 3a is fixed to one of the lids 12, and a negative current collector terminal 3b is fixed to the other lid 12.

The intervening member 51 consists of an elastically deformable elastic member 51a and an insulating member 51b and serves to prevent the restraining load P1 from excessively increasing when the pressure inside the battery can 1 rises. However, the intervening member 51 is not limited to this, but may be a member having elasticity and insulation properties, for example, ethylene propylene rubber (EPDM). The restraint mechanism 5 includes a pair of side pressure plates 52 that press the long side portions 111 of the outermost battery cells 10 via the insulating members 51b sandwiched therebetween, a base 53 that supports the lower end portions of the side pressure plates 52, and a connecting plate (not shown) that connects the left and right side pressure plates 52. The battery cells 10 restrained by the restraint mechanism 5 are electrically connected via bus bars (not shown) at the respective current collector terminals 3 (the positive current collector terminals 3a and the negative current collector terminals 3b).

The restraint mechanism 5 also includes a cooling unit 54 that contacts the lower short side portions 112b and cools the battery cells 10, and protrusions 55 are formed on the upper surface of the cooling unit 54. The widthwise opposite end portions 115 of the lower short side portions 112b can be engaged with the protrusions 55 from above. The cooling unit 54 is fixed to the base 53, and a coolant passage 541 having substantially the same width as the battery cell 10 is formed along the axial direction (the Z direction) at a position opposed to each battery cell 10. The cooling unit 54 may be formed by extrusion molding along the axial direction (the Z direction). The cooling unit 54 may be divided into sections corresponding to the respective battery cells 10, and the protrusions 55 may be formed at the widthwise opposite end portions of the respective sections.

Each of the protrusions 55 is divided into two protrusions 55a, 55b formed on the left and right between adjacent ones of the coolant passages 541, i.e., between the widthwise opposite end portions 115 of the lower short side portions 112b of the adjacent battery cells 10. Between the two protrusions 55a, 55b, a gap 116 that allows deflection of the protrusions 55a, 55b during engagement of the widthwise opposite end portions 115 with the protrusions 55a, 55b is formed. In this embodiment, the protrusions 55 (55a, 55b) are formed integrally with the cooling unit 54, but they may be formed separately.

With the above configuration, even when the pressure inside the battery can 1 rises due to a rise in the temperature of the battery cell 10 during rapid charging of the battery pack 10P, for example, or when the electrode body 2 expands in volume as the battery cell 10 that constitutes the battery pack 10P ages and deteriorates, the lower short side portion 112b of the extruded case body 11 where the protrusions 55 of the cooling unit 54 are engaged with the widthwise opposite end portions 115 is less likely or unlikely to deform downward in an arc shape and is likely to be kept in contact with the cooling unit 54. Accordingly, the reduction in the contact area between the lower short side portion 112b and the cooling unit 54 can be suppressed, and an increased quantity of heat can be dissipated through the lower short side portion 112b in contact with the cooling unit 54. As a result, the battery cells 10 in the battery pack 10P can be effectively cooled.

The widthwise opposite end portions 115 of the lower short side portion 112b of each battery cell 10 are pressed from above (in the Q direction in FIG. 3) to be engaged from above with the protrusions 55 formed on the upper surface of the cooling unit 54. In this manner, even if pressure is applied to the battery cells 10 from the opposite ends in the stacking direction (the X direction), displacement of each battery cell 10 relative to the restraint mechanism 5 can be avoided, and the snake phenomenon of the battery cells 10 curved in the stacking direction (the X direction) can be suppressed. As a result, the battery pack 10P that can suppress reduction in the cooling performance of the battery cells 10 and the snake phenomenon with a simple structure can be provided.

In the battery pack 10P, the thickness d2 of the lower short side portion 112b is preferably larger than the thickness d1 of the upper short side portion 112a. In this case, even when the upper short side portion 112a with the smaller thickness d1 deforms due to a rise in the pressure inside the battery can 1 or an increase in the volume of the electrode body 2, the lower short side portion 112b with the larger thickness d2 is less likely to deform. Therefore, when the pressure inside the battery can 1 rises or when the electrode body 2 expands in volume as the battery cell 10 ages and deteriorates, heat can be more reliably dissipated to the cooling unit 54 through the lower short side portion 112b that is less likely to deform, and the battery cells 10 that constitute the battery pack 10P can be more effectively cooled.

In this embodiment, the thickness d2 of the lower short side portion 112b is constant over the entire width and is uniformly larger than the thickness d1 of the upper short side portion 112a. However, the configuration of the battery cell 10 is not necessarily limited to this. For example, only the corner portions where the long side portions 111 and the lower short side portion 112b cross each other may be formed with the thickness d2 larger than the thickness d1 of the upper short side portion 112a, as indicated by virtual lines KS in FIG. 3. In this case, the space for accommodating the electrode body 2 can be expanded, which contributes to improvement of the energy density of the battery cell 10.

In the battery pack 10P, it is preferable that the widthwise opposite end portions 115 are formed with arc surfaces CS protruding outward in the width direction and extending along the axial direction (the Z direction), and the protrusions 55 are formed so as to be able to elastically deform and engage with the arc surfaces CS. The protrusion 55 is formed with a concave arc surface that contacts the arc surface CS. In this case, when the lower short side portion 112b of each battery cell 10 is brought into contact with the cooling unit 54 from above, the protrusions 55 of the cooling unit 54 are pressed by the arc surfaces CS of the lower short side portion 112b and elastically deform outward in the width direction. Then, the protrusions 55 resume the original shape after passing the arc surfaces CS. In this manner, the protrusions 55 of the cooling unit 54 can be resiliently engaged with the widthwise opposite end portions 115 of the lower short side portion 112b. Therefore, in the engaged state of the widthwise opposite end portions 115 and the protrusions 55, the protrusions 55 of the cooling unit 54 grip the widthwise opposite end portions 115 of the lower short side portion 112b with the resilient force P2, so that the lower short side portion 112b becomes less likely or unlikely to separate from the cooling unit 54. Accordingly, the battery cells 10 that constitute the battery pack 10P can be more effectively cooled.

### Modified Examples

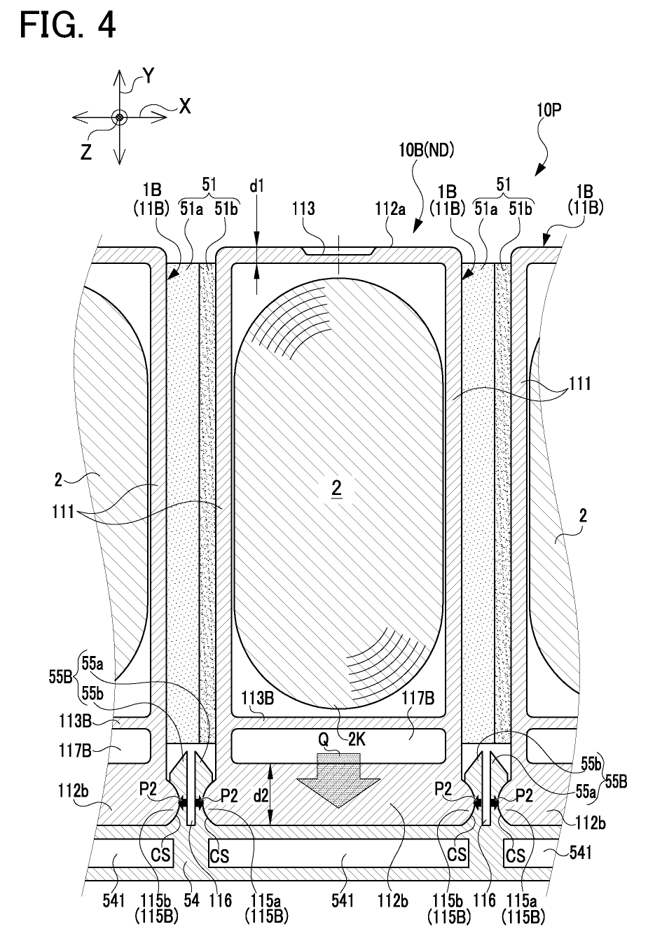

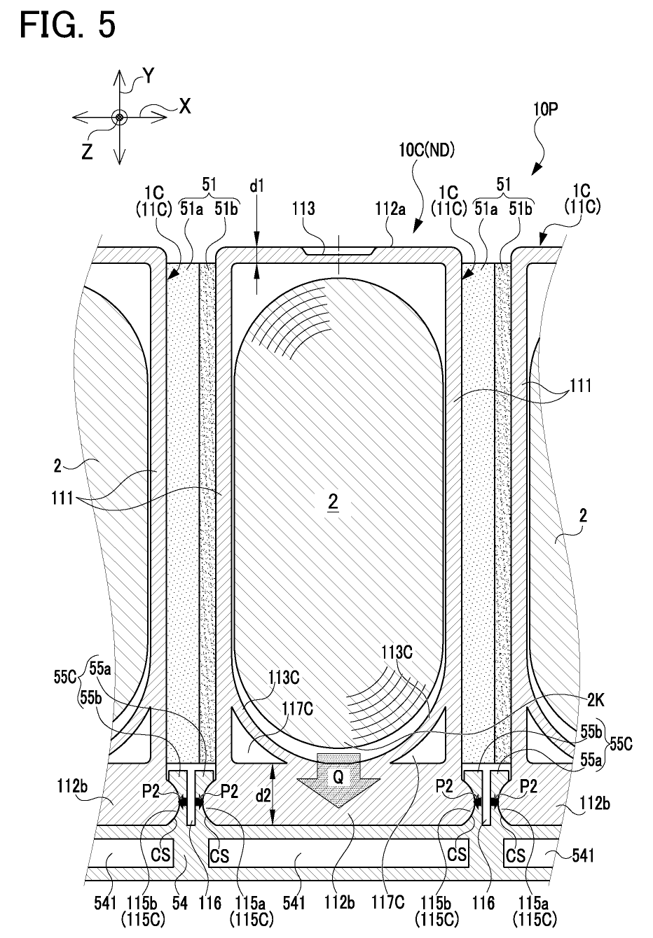

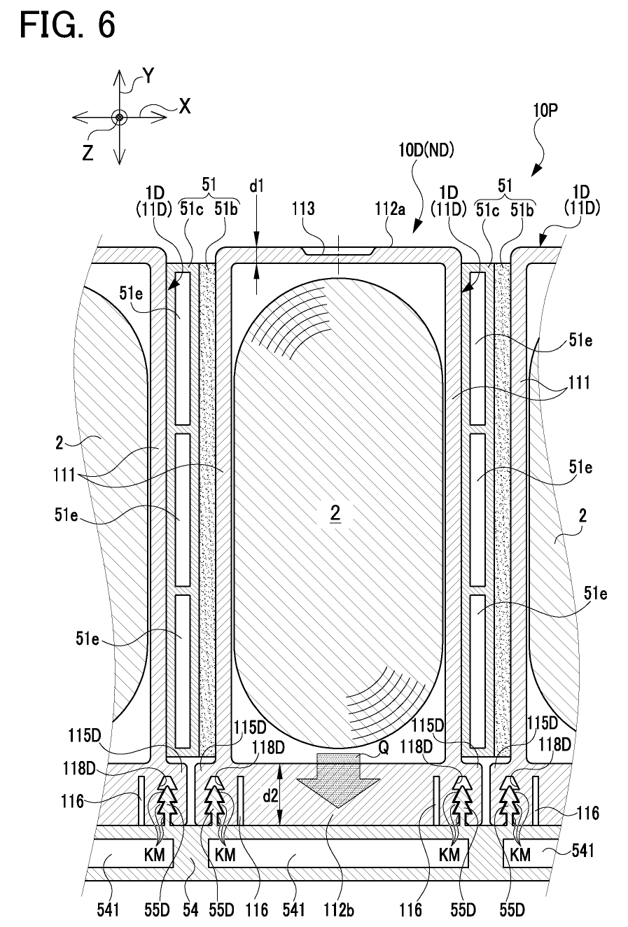

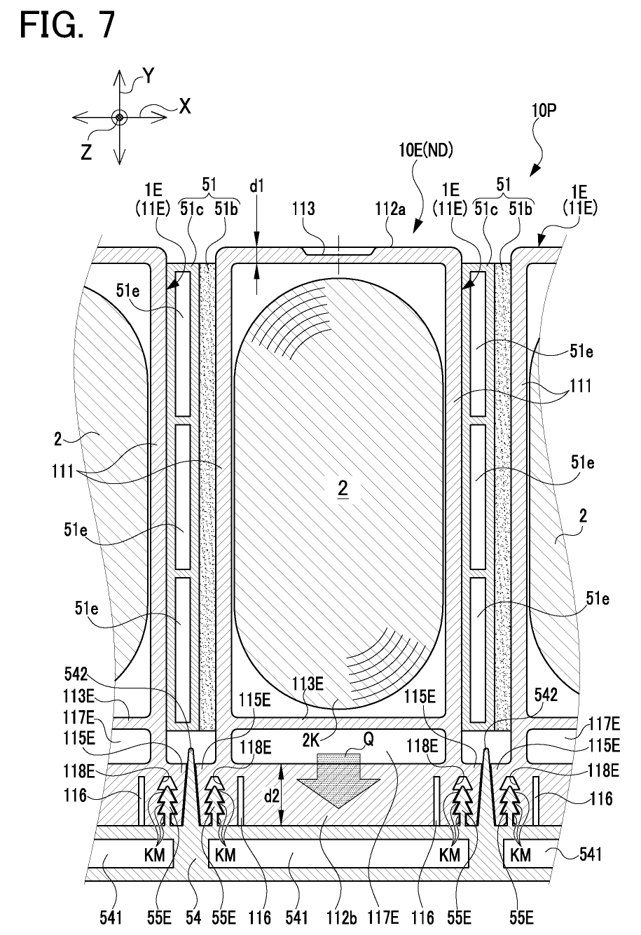

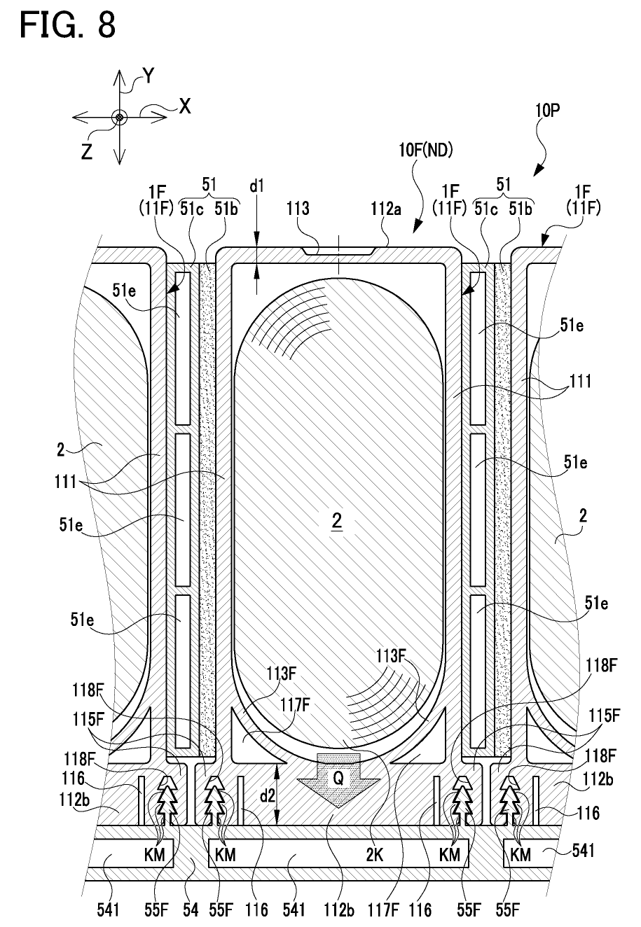

The embodiment described in detail above is a merely illustrative example and does not limit the disclosure in any way. Thus, the disclosure may be subject to various improvements and modifications without departing from its principle. FIG. 4 is an enlarged cross-sectional view of part A in a first modified example of the battery pack shown in FIG. 1. FIG. 5 is an enlarged cross-sectional view of part A in a second modified example of the battery pack shown in FIG. 1. FIG. 6 is an enlarged cross-sectional view of part A in a third modified example of the battery pack shown in FIG. 1. FIG. 7 is an enlarged cross-sectional view of part A in a fourth modified example of the battery pack shown in FIG. 1. FIG. 8 is an enlarged cross-sectional view of part A in a fifth modified example of the battery pack shown in FIG. 1.

The battery pack 10P described above may be modified as shown in FIGS. 4, 5, 7, and 8, provide battery packs 10P of the first, second, fourth, and fifth modified examples. In each of the modified examples, the extruded case body 11B, 11C, 11E, 11F includes a partition wall portion 113B, 113C, 113E, 113F that extends in the axial direction (the Z direction) between the lower short side portion 112b and the lower end portion 2K of the electrode body 2 to connect the long side portions 111 or connect the long side portions 111 and the lower short side portion 112b. In addition, a coolant passage or passages 117B, 117C, 117E, 117F is/are formed between the partition wall portion 113B, 113C, 113E, 113F, the long side portion 111, and the lower short side portion 112b.

In this case, the coolant that flows through the coolant passage 117B, 117C, 117E, 117F formed between the partition wall portion 113B, 113C, 113E, 113F, the long side portions 111, and the lower short side portion 112b further improves the cooling performance of the battery cell 10B, 10C, 10E, 10F that constitutes the battery pack 10P.

Consequently, even when the pressure inside the battery can 1B, 1C, 1E, 1F rises due to a rise in the temperature of the battery cell 10B, 10C, 10E, 10F during rapid charging of the battery cell 10B, 10C, 10E, 10F, for example, or when the electrode body 2 expands in volume as the battery cell 10B, 10C, 10E, 10F ages and deteriorates, heat can be dissipated to the cooling unit 54 through the lower short side portion 112b that is even less likely to deform, and heat can also be dissipated through the coolant flowing in the coolant passage 117B, 117C, 117E, 117F of the battery can 1B, 1C, 1E, 1F, so that the battery cell 10B, 10C, 10E, 10F that constitutes the battery pack 10P can be even more effectively cooled.

The battery pack 10P described above may also be modified as shown in FIGS. 6, 7, and 8, to provide battery packs 10P of the third, fourth, and fifth modified examples. In the widthwise opposite end portions 115D, 115E, 115F of the lower short side portion 112b of each of the modified examples, elastically deformable engaging claws KM extending in the axial direction (the Z direction) are provided in inside walls 118D, 118E, 118F that are recessed upward from the bottom surface of the lower short side portion 112b, and the protrusions 55D, 55E, 55F are formed so that they can engage with the engaging claws KM from below.

In this case, when the lower short side portion 112b of each battery cell 10D, 10E, 10F is brought into contact with the cooling unit 54 from above, the protrusions 55D, 55E, 55F of the cooling unit 54 can be fitted in the widthwise opposite end portions 115D, 115E, 115F of the lower short side portion 112b, in a condition where the protrusions 55D, 55E, 55F of the cooling unit 54 engage with the engaging claws KM formed in the inside walls 118D, 118E, 118F of the widthwise opposite end portions 115D, 115E, 115F of the lower short side portion 112b. Therefore, in this engaged state, the lower short side portion 112b contacts the cooling unit 54, and is less likely or unlikely to separate from the cooling unit 54. Accordingly, the battery cell 10D, 10E, 10F that constitutes the battery pack 10P can be even more reliably cooled.

In the battery packs 10P of the third, fourth, and fifth modified examples, the widthwise opposite end portions 115D, 115E, 115F may have grooves 116 formed at positions adjacent to and widthwise inwardly of the inside walls 118D, 118E, 118F such that the grooves 116 are recessed upward from the bottom surface to substantially the same depth as the inside walls 118D, 118E, 118F. In this case, it becomes even easier for the protrusions 55D, 55E, 55F to engage with the engaging claws KM from below.

In the battery pack 10P of the first modified example, as shown in FIG. 4, inclined guide surfaces that guide the widthwise opposite end portions 115B of the lower short side portions 112b may be formed on the upper end portions of the protrusions 55B. In the battery pack 10P of the fourth modified example, as shown in FIG. 7, inverted V-shaped guide surfaces 542 that guide the widthwise opposite end portions 115E of the lower short side portions 112b of the adjacent battery cells 10E may be formed on the upper surface of the cooling unit 54. In these cases, the widthwise opposite end portions 115B, 115E of the lower short side portions 112b of the battery cells 10B, 10E can be more easily engaged from above with the protrusions 55B, 55E formed on the upper surface of the cooling unit 54.

In the battery packs 10P of the third, fourth, and fifth modified examples, as shown in FIGS. 6, 7, and 8, cooling plates 51c that have a plurality of coolant passages 51e and are elastically deformable may be provided between the long side portions 111. In this case, the cooling performance of the battery cells 10D, 10E, 10F can be further improved.

### Reference Signs List

1, 1B, 1C, 1D, 1E, 1F Battery can
2 Electrode body
2K Lower end portion 5
Restraint mechanism
10, 10B, 10C, 10D, 10E, 10F Battery cell
10P Battery pack
11, 11B, 11C, 11D, 11E, 11F Extruded case body
11T End portion
12 Lid
51 Intervening member
54 Cooling unit
55, 55B, 55C, 55D, 55E, 55F Protrusion
111 Long side portion
112a Upper short side portion 112b Lower short side portion
113B, 113C, 113E, 113F Partition wall portion 115, 115B, 115C Widthwise opposite end portion
115D, 115E, 115F Widthwise opposite end portion
117B, 117C, 117E, 117F Coolant passage
118D, 118E, 118F Inside wall
CS Arc surface
KM Engaging claw
ND Secondary battery

What is claimed is:

1. A battery pack comprising:
a plurality of battery cells that constitute a secondary battery, each of the battery cells having an electrode body, and a battery can made of metal and comprising an extruded case body in the form of a quadrangular tube that contains the electrode body and is open at opposite ends in an axial direction, and a pair of lids that seal the opposite ends of the extruded case body, the extruded case body having a pair of long side portions extending in the axial direction, and an upper short side portion and a lower short side portion perpendicular to the long side portions; and
a restraint mechanism that holds the battery cells in place by applying pressure to the battery cells from opposite ends in a stacking direction in which the battery cells are stacked with intervening members sandwiched between the long side portions,
wherein the restraint mechanism includes a cooling unit that contacts the lower short side portion of each of the battery cells and cools the battery cells, and
wherein the lower short side portion has widthwise opposite end portions formed to be engageable from above with protrusions formed on an upper surface of the cooling unit.

2. The battery pack according to claim 1, wherein the lower short side portion has a larger thickness than the upper short side portion.

3. The battery pack according to claim 1, wherein:
the widthwise opposite end portions have arc surfaces that protrude outward in a width direction and extend along the axial direction; and
the protrusions are elastically deformable and engageable with the arc surfaces.

4. The battery pack according to claim 2, wherein:
the widthwise opposite end portions have arc surfaces that protrude outward in a width direction and extend along the axial direction; and
the protrusions are elastically deformable and engageable with the arc surfaces.

5. The battery pack according to claim 1, wherein:
the widthwise opposite end portions have inside walls that are recessed upward from a bottom surface of the lower short side portion, the inside walls being provided with engaging claws that are elastically deformable and extend along the axial direction; and
the protrusions are engageable with the engaging claws from below.

6. The battery pack according to claim 2, wherein:
the widthwise opposite end portions have inside walls that are recessed upward from a bottom surface of the lower short side portion, the inside walls being provided with engaging claws that are elastically deformable and extend along the axial direction; and
the protrusions are engageable with the engaging claws from below.

7. The battery pack according to claim 1, wherein:
the extruded case body includes a partition wall portion that extends in the axial direction between the lower short side portion and a lower end portion of the electrode body, to connect the long side portions or the long side portion and the lower short side portion; and
the extruded case body has a coolant passage between the partition wall and the long side portions and the lower short side portion.

8. The battery pack according to claim 2, wherein:
the extruded case body includes a partition wall portion that extends in the axial direction between the lower short side portion and a lower end portion of the electrode body, to connect the long side portions or the long side portion and the lower short side portion; and
the extruded case body has a coolant passage between the partition wall and the long side portions and the lower short side portion.

9. The battery pack according to claim 3, wherein:
the extruded case body includes a partition wall portion that extends in the axial direction between the lower short side portion and a lower end portion of the electrode body, to connect the long side portions or the long side portion and the lower short side portion; and
the extruded case body has a coolant passage between the partition wall and the long side portions and the lower short side portion.

10. The battery pack according to claim 4, wherein:
the extruded case body includes a partition wall portion that extends in the axial direction between the lower short side portion and a lower end portion of the electrode body, to connect the long side portions or the long side portion and the lower short side portion; and
the extruded case body has a coolant passage between the partition wall and the long side portions and the lower short side portion.

11. The battery pack according to claim 5, wherein:
the extruded case body includes a partition wall portion that extends in the axial direction between the lower short side portion and a lower end portion of the electrode body, to connect the long side portions or the long side portion and the lower short side portion; and
the extruded case body has a coolant passage between the partition wall and the long side portions and the lower short side portion.

12. The battery pack according to claim 6, wherein:
the extruded case body includes a partition wall portion that extends in the axial direction between the lower short side portion and a lower end portion of the electrode body, to connect the long side portions or the long side portion and the lower short side portion; and
the extruded case body has a coolant passage between the partition wall and the long side portions and the lower short side portion.
